(19) United States
(12) Patent Application Publication
(10) Pub. No.: US 2014/0172622 A1
(43) Pub. Date: Jun. 19, 2014

(54) SELECTING AND SCROLLING MEDIA CONTENT ASSOCIATED WITH MEDIA CONTENT ITEMS

(71) Applicant: RAWLLIN INTERNATIONAL INC., Tortola (VG)

(72) Inventor: Ilya Baronshin, Saint Petersburg (RU)

(73) Assignee: RAWLLIN INTERNATIONAL INC., Tortola (VG)

(21) Appl. No.: 13/715,963

(22) Filed: Dec. 14, 2012

(51) Int. Cl. G06F 3/0482

(52) U.S. Cl. CPC G06F 3/0482; G06Q 30/0631
USPC 705/26.7; 715/716

(57) ABSTRACT

A media content item is associated with one or more of the media content items based on a similarity of a feature of the media content items and displaying such one or more media content items as a scrollable set of image icons. Also, the scrollable set of image icons can enable playback, rewind, forward, search, pause, or record for selection at a user device. In an aspect, a shopping bag component can enable selection of a subset of the media content items for storage in association with bag data representative of a bag, wherein the subset of the media content items associated with the bag data are at least one of stored, accessed, shared, or purchased by the user device. Furthermore, in an aspect, the subset of the media content items associated with the bag data are searchable as a scrollable set of image icons for selection at the user device.

### TECHNICAL FIELD

This disclosure relates to media content, e.g., storing, receiving, associating, and displaying media content items as a scrollable choice for user selection and consumption.

### BACKGROUND

Consumers of media content items often search for media content items to consume via performing search queries or browsing through libraries. Often times consumers will consume media content items that are similar to media content items already previously consumed. For instance, a consumer who viewed a video of a soap opera episode will likely later view the next soap opera episode in the series. Currently, a consumer faces the burden of seeking out various media content items for consumption which can be burdensome, time consuming, inefficient and lacking organization.

The above-described deficiencies associated with scrolling, browsing, and searching media content items are merely intended to provide an overview of some of the problems of conventional systems, and are not intended to be exhaustive. Other problems with the state of the art and corresponding benefits of some of the various non-limiting embodiments may become further apparent upon review of the following detailed description.

### SUMMARY

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments in a simplified form as a prelude to the more detailed description of the various embodiments that follow. In accordance with one or more embodiments and corresponding disclosure, various non-limiting aspects are described in connection with a scrollable menu system are described herein based on social graph information and user preferences.

In accordance with a non-limiting embodiment, in an aspect, a scrollable menu system is provided comprising a memory having stored thereon computer executable components, and a processor configured to execute the following computer executable components stored in the memory: a data storage component that stores data associated with media content items; a receiving component that receives the data associated with the media content items for consumption on a user device based on at least one of selection data representing a selection received from the user device or a user preference inferred for a user identity associated with the user device; an association component that associates a media content item with one or more of the media content items based on a similarity of a feature of the media content items determined with respect to one or more features of the one or more of the media content items; and a display component that displays the one or more of the media content items as a scrollable set of image icons associated with respective media content items that respectively enable playback, rewind, forward, search, pause, or record for selection at the user device.

In another non-limiting embodiment, a method is provided, comprising Receiving, by a system including a processor, data associated with a set of media content items; storing the data associated with the set of media content items; identifying a media content item candidate from the set of media content items based on an association factor with a media content item located in a sharable electronic shopping bag; accessing data associated with the media content item candidate for at least one of facilitating: a browsing of the media content item candidate, a selection of the media content item candidate, a viewing of the media content item candidate, or a purchase of the media content item candidate; and presenting the candidate media content items as a scrollable set of image icons associated with the media content items in the sharable electronic shopping bag.

Still, in yet another non-limiting embodiment, a computer-readable storage medium comprising computer-readable instructions is provided that, in response to execution, cause a computing system to perform operations, comprising receiving data associated with a media content item of media content items; storing data related to the media content items based on a user preference for user consumption; identifying a media content item candidate for association with a media content item determined to be included in a sharable electronic shopping bag based on a predetermined attribute; accessing a portion of the data associated with the media content items in connection with generating a search result in response to a search request or transmitting content in response to a request for consumption; and presenting the media content items associated with the portion of the data arranged as a scrollable set of tiles.

In various aspects, the scrollable menu system can further comprise a categorization component that categorizes the scrollable set of image icons into categories of at least one of: not purchased items, purchased and ready to playback items, continue playback items, already watched play again items, or not purchased items. In an instance, an embodiment can include comprise a shopping bag component that enables selection of a subset of the media content items for storage in association with bag data representative of a bag, wherein the subset of the media content items associated with the bag data are at least one of stored, accessed, shared, or purchased by the user device. Further, in another embodiment, the scrollable menu system can further comprise a permissions component that grants or denies a member request to access the subset of the media content items associated with the bag data as a function of at least one predetermined member permission criterion

The following description and the annexed drawings set forth certain illustrative aspects of the disclosure. These aspects are indicative, however, of but a few of the various ways in which the principles of the disclosure may be employed. Other advantages and novel features of the disclosure will become apparent from the following detailed description of the disclosure when considered in conjunction with the drawings.

### BRIEF DESCRIPTION OF THE DRAWINGS

FIG. 1 illustrates an example non-limiting system for selecting and scrolling media content items.

FIG. 2 illustrates an example non-limiting system for selecting, scrolling, and categorizing media content items.

FIG. 3 illustrates an example non-limiting system for selecting, scrolling, and categorizing media content associated with media content items in a bag.

FIG. 4 illustrates an example non-limiting system for selecting, scrolling, and permitting devices access to media content associated with media content items in a bag.

FIG. 5 illustrates an example non-limiting system for selecting, scrolling, and sharing media content associated with media content items in a bag.

FIG. 6 illustrates an example non-limiting for selecting and scrolling, media content associated with media content items in a bag.

FIG. 7 illustrates an example non-limiting embodiment scrollable menu display in accordance with a user device.

FIG. 8 illustrates an example non-limiting embodiment scrollable menu display in accordance with a user device.

FIG. 9 is a block diagram showing an exemplary non-limiting example of a social graph.

FIG. 10 illustrates an example method for receiving, storing, identifying, accessing, presenting media content items and data associated with media content in accordance with various aspects and implementations described herein;

FIG. 11 illustrates an example method for receiving, storing, identifying, accessing, presenting media content items and data associated with media content in accordance with various aspects and implementations described herein;

FIG. 12 illustrates an example method for receiving, storing, identifying, accessing, presenting media content items and data associated with media content in accordance with various aspects and implementations described herein;

FIG. 13 illustrates an example method for receiving, storing, identifying, accessing, presenting media content items and data associated with media content in accordance with various aspects and implementations described herein;

FIG. 14 illustrates an example method for receiving, storing, identifying, accessing, presenting media content items and data associated with media content in accordance with various aspects and implementations described herein;

FIG. 15 illustrates an example method for receiving, storing, identifying, accessing, presenting media content items and data associated with media content in accordance with various aspects and implementations described herein;

FIG. 16 illustrates an example method for receiving, storing, identifying, accessing, presenting media content items and data associated with media content in accordance with various aspects and implementations described herein;

FIG. 17 illustrates a block diagram representing exemplary non-limiting networked environments in which various non-limiting embodiments described herein can be implemented; and

FIG. 18 illustrates a block diagram representing an exemplary non-limiting computing system or operating environment in which one or more aspects of various non-limiting embodiments described herein can be implemented.

### DETAILED DESCRIPTION

In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment,” or “an embodiment,” means that a particular feature, structure, or characteristic described in connection with the embodiment is included in at least one embodiment. Thus, the appearances of the phrase “in one embodiment,” or “in an embodiment,” in various places throughout this specification are not necessarily all referring to the same embodiment. Furthermore, the particular features, structures, or characteristics may be combined in any suitable manner in one or more embodiments.

As utilized herein, terms “component,” “system,” “interface,” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In an aspect, a component can emulate an electronic component via a virtual machine, e.g., within a cloud computing system.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

In addition, the disclosed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable media. For example, computer-readable media can include, but are not limited to, a magnetic storage device, e.g., hard disk; floppy disk; magnetic strip(s); an optical disk (e.g., compact disk (CD), a digital video disc (DVD), a Blu-ray Disc™ (BD)); a smart card; a flash memory device (e.g., card, stick, key drive); and/or a virtual device that emulates a storage device and/or any of the above computer-readable media.

Often, users who utilize devices (herein referred to as device users) to consume media content items seek to view content items similar in some manner with respect to the media content items historically viewed or recently viewed. A device user may seek to consume content related to a genre associated with already viewed content or have some feature similar to the previously viewed media content item. Accordingly, various embodiments herein enable users to scroll through media content items as actionable image icons whereby the icons represent media content items that share a similar feature to media content items previously consumed or viewed. As merely one example, where a user finished viewing episode 1 of a soap opera, a scrollable menu display can be presented to the user whereby episode 2 of the soap opera may be selected or purchased in addition to alternative selection options sharing a similar feature with episode 1 of the soap opera.

A scrollable menu system facilitates easier user consumption of preferred media content items by recommending or suggesting other media content items to consume based on similarity factors. The scrollable menu system saves the user the effort required to seek out media content items related to items previously consumed or viewed. Furthermore, the scrollable menu system provides for a set of images rather than text for users to scroll through thus allowing the user to identify the desired media content item without exerting interactive effort associated with reading (e.g. eye movement, more user observations required, etc.). Also, a user can sample the media content item within the scrollable menu, whereby the image icon comprises data allowing for playback, stop, forward, rewind, and other such viewing features. Additionally, the scrollable menu items can comprise information regarding a user's history with a media content item, such as, whether a user previously purchased or viewed the media content item. The scrollable menu system provides numerous benefits and efficiencies to users who seek to consume media content items.

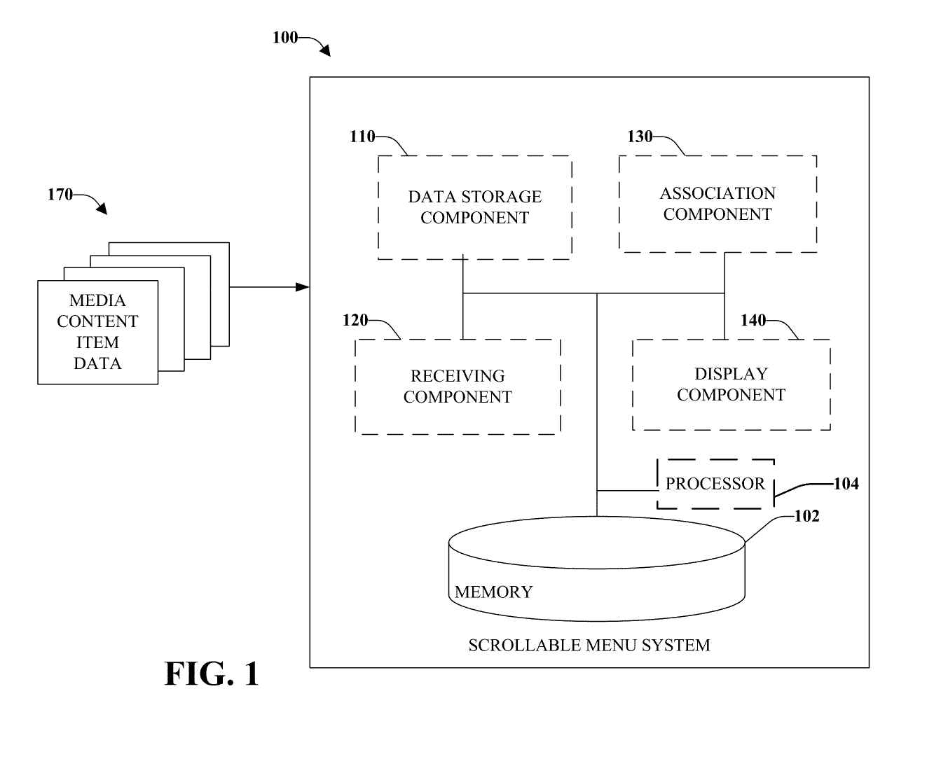

Referring now to the drawings, with reference initially to FIG. 1, presented is a system 100 that can facilitate scrolling through image icons that represent media content items based on similarity factors to other media content items. Aspects of the systems, apparatuses or processes explained herein can constitute machine-executable component embodied within machine(s), e.g., embodied in one or more computer readable mediums (or media) associated with one or more machines. Such component, when executed by the one or more machines, e.g., computer(s), computing device(s), virtual machine(s), etc. can cause the machine(s) to perform the operations described. System 100 can include memory 102 for storing computer executable components and instructions. A processor 104 can facilitate operation of the computer executable components and instructions by the system 100.

In an aspect, system 100 enables the scrolling through media content items represented as image icons. In an aspect, media content items can refer to media content item data associated with one or more data sources (not shown) that can be accessed by system 100 (and additional systems described in this disclosure). For example, a data source can include a data store storing media content and affiliated with a content provider that interacts with the system 100. In another aspect, a data source can include a data store that stores media content remote from a content provider or a blended ranking system 100. In an aspect, media content items 170 can include media data as media items. For example, the media content items 170 can include one or more media items (e.g., video and/or audio including but not limited to movies, television, streaming television, video games, music tracks . . . ). In an aspect, the media content items data 170 can be at least one of a movie item, audio item, image item, or digital print item (e.g. newspaper, blog, on-line magazine, etc.).

In an aspect, a system 100 (or additional systems described in this disclosure) can be configured to access the media content items 170 via a network such as for example the Internet, intranet, or cellular service. In another aspect, the system 100 (or additional systems described in this disclosure) may be configured for use by a media-rendering device. A media rendering device can include any suitable device associated with a user and configured to interact with or receive the set images associated with the media content items 170 (e.g. streaming video, audio downloads, etc.) from system 100. For example, a media rendering device can include a desktop computer, a laptop computer, a smart phone, a media player, a portable electronic device, a tablet personal computer, or a personal digital assistant (PDA). As used in this disclosure, the terms “content consumer” or “user” refer to a person, entity, system, or combination thereof that employ system 100 (or additional systems described in this disclosure).

In an embodiment, system 100 includes data storage component 110, receiving component 120, association component 130, and display component 140. The data storage component 110 is configured to store data associated with media content items 170. The receiving component 120 is configured to receive the data associated with the media content items 170 for consumption on a user device based on at least one of selection data representing a selection received from the user device or a user preference inferred for a user identity associated with the user device. The association component 130 is configured to associate a media content item 170 with one or more of the media content items 170 based on a similarity of a feature of the media content items 170 determined with respect to one or more features of the one or more of the media content items 170. The display component 140 is configured to display the one or more of the media content items 170 as a scrollable set of image icons associated with respective media content items that respectively enable playback, rewind, forward, search, pause, or record for selection at the user device.

In an aspect, data storage component 110 is configured to store data associated with media content items 170. A data storage component 110 is a medium for storing data such as audio data, video data, image data, electronic data, qualitative data, categorical data, quantitative data, integers, Booleans, characters, and other such data types. In an aspect, data storage component 110 can store different types of data associated with media content items 170, such as various types of libraries, files, applications, video content, audio content, etc. as well as search data stores of third party servers, cloud resources, or data stores of user devices, such as mobile devices.

Receiving component 120 receives the data associated with the media content items 170 for consumption on a user device based on at least one of selection data representing a selection received from the user device or a user preference inferred for a user identity associated with the user device. Receiving component 120 in connection with data storage component 110 can receive selection data associated with media content items 170. A user can utilize a user device (e.g. mobile device, set-top box, desktop computer, personal digital assistant, etc.) to select a media content item 170, such as a video, song, or image. The received selection data associated with the media content items 170 represents a selection received from the user device or a user preference inferred for a user identity associated with the user device.

When a user selects a media content item 170 on a user device, the data associated with the selected media content item 170 can be received by receiving component 170. For instance, if a user selects and views a movie starring Angelina Jolie, the data associated with the Angelina Jolie movie can be received by the receiving component 120. Furthermore, data associated with other Angelina Jolie movie's can also be accessed by the receiving component 120, whereby if the user desires to view another movie starring Angelina Jolie, the data associated with other Angelina Jolie movies is readily available for access by the user device. In an aspect, receiving component 120 can also receive selection data representative of a user preference inferred for a user identity associated with the user device.

A user preference is information that identifies characteristics, attributes, or types of data associated with media content items 170 a user prefers to consume. The user preference can include aspects of data related to media content items 170 a user previously accessed, viewed, or consumed. For instance, a user preference can account for the genre of media content items 170 a user previously consumed. Thus, if a user is an avid viewer of scary movies and has previously viewed numerous Alfred Hitchcock films, then receiving component 170 can receive data associated with other scary movies such as the Nightmare on Elm Street series.

Additionally, a user preference can be determined by identifying a user identity associated with a user device. A user identity is a particular identifying feature that associates a particular user with particular data. A user identity can be determined by passwords, verification processes, sign-in inputs, portals, saved settings, device locks, and other such user identifying features. Furthermore, user preferences associated with a user identity can be inferred from user identity information such as age, relationship status, profession, gender, financial status, hobbies, interests, geographic location, sexual orientation, religious belief, culture, ethnicity, or other such user characteristics. Thus if a user is professional chef, receiving component 120 can receive data associated with media content items 170 that relate to cooking such as audio cookbooks or food preparation video's.

The association component 130 associates a media content item 170 with one or more of the media content items 170 based on a similarity of a feature of the media content items 170 determined with respect to one or more features of the one or more of the media content items 170. The media content items 170 can share a feature in common with other media content items 170. Features of similarity are attributes of media content items 170 that allow grouping of the media content items 170 by some commonality or correlation such as a classification, category, series, or genre. For instance, if a media content item 170 is a video, the video can be associated with one or more videos based on a similarity of features such as a set of titles, set of episodes, format, or genre corresponding to the respective video. Thus association component 130 can associate a hi-definition video with one or more other videos presented in a hi-definition format.

Furthermore, a media content item 170 that is an audio file can be associated with one or more other audio files by association component 130 based on similarity features such as an artist, composer, producer, music label, instrument, concert series, compilation, album title, music genre, and other such features. In an aspect, the association component 130 can associate media content items 170 of a with one or more media content items 170 of different data types. For instance, association component 130 can associate a video of a famous movie with an audio soundtrack of the famous movie and an image of a poster related to the famous movie. There are numerous features of similarity among media content items 170 which allow association component 170 to group, categorize, compare, characterize, and devise linkages through the act of association.

In another aspect, association component 130 can associate a media content item 170 with one or more media content items 170 based on similarity features such as user interactions with a device data. A user can operate the menu scrolling system and conduct activities related to media content data at the user device. In an instance, a user can purchase, add to favorites, bookmark, view, playback, save, or perform other actions at a user device to accomplish such tasks related to media content items 170. Association component 130 can utilize these user activities related to media content items 170 to associate with one or more media content items 170 whereby a user performed an activity related to the media content item 170. For example, association component 130 may associate a media content item 170 purchased by a user with one or more other media content items 170 purchased by friends of the user who purchased the same media content item 170 as the user. For instance, association component 130 can associate a cookbook with a restaurant rating guide the user and the users' friend purchased. In another aspect, association component 170 can associate a media content item 170 with similar media content items 170 bookmarked by a user.

In yet another embodiment, association component 130 can employ an algorithm to associate a media content item 170 with one or more media content items 170. In an aspect, the algorithm can measure the similarity of text between sets of data such as the percentage of words in common between the data sets. Also, in an aspect, the algorithm can compare similar content to identify a content performance attribute of one or more video frames and assess similarities in color, texture, shape, motion and other performance attributes. In the event that a frame to frame association is derived, the association component 130 can employ an algorithm to rank associations by identifying the number of pairs of similar frames between media data sets and ranking the higher data sets with more sets of frames in common as having a higher ranked association than data sets with a lower number of similar frame sets. For instance, multiple episodes of soap opera series often have the same introductory opening (and often an accompanying opening theme song) or closing credits whereby numerous episodes contain the same opening and closing video frames. Thus by performing a frame by frame association, association component 130 via an algorithm can associate different episodes of a soap opera series with one another.

A display component 140 displays the one or more of the media content items 170 as a scrollable set of image icons associated with respective media content items 170 that respectively enable playback, rewind, forward, search, pause, or record for selection at the user device. In order to select media content items 170 for consumption, a user can scroll through a set of media content items 170 options at the user device. A display component 140 displays the media content items 170 options as a scrollable set of images that represent the media content items 170 for visual identification of the media content item 170 the user desires to consume. For instance, a user wishing to listen to an audio book may scroll through images of the cover page of the paper version of the book. Furthermore, a user seeking to consume a movie video can scroll through images of various frames of different movies representing respective movies for user viewing.

In an aspect, the host, administrator, or owner of the media content item 170 can choose the respective image icons to represent the media content items 170. An image depicting a climactic action moment or showcasing enhanced graphic effects may capture the attention of a user over other less captivating images. The ability to choose an image can be useful for hosts, advertisers, retailers, or other promoters of the media content items 170. Furthermore, a user may choose an image to display as a representation of a media content items 170 for purposes of sharing with another user or personal satisfaction when browsing through a personal library of media content items 170.

In an aspect, the set of images are scrollable thereby enabling a user, via a device, to pan across image icons. The scrolling may take place at various speeds, which can be adjusted by the user. For instance, the set of images can occur in discrete increments whereby after sliding across each image a pause occurs. Furthermore, the scrolling can take place as one smooth glide-like transition. The frame rate by which the images slide can be fast or slow and can be subject to manual or automatic adjustment by a user or host of the scrollable set of images. Further, in an aspect, the image icon size can be adjusted to small or large images depending on an image sizing option setting chosen by the user or host.

In another aspect, the user can not only browse the set of image icons but can playback, rewind, forward, search, pause, or record the media content items 170 at the user device. The image icons represent the media content items 170 and also allow a user to click on the image icon to preview or fully consume the corresponding media content item 170. The set of image icons comprise the respective media content items 170 data so that a user simply can playback, rewind, forward, search, pause, or record a media content item 170 without linking to another web page. This convenience allows users to save time, effort, and have a superior user experience related to browsing and consuming media content items 170.

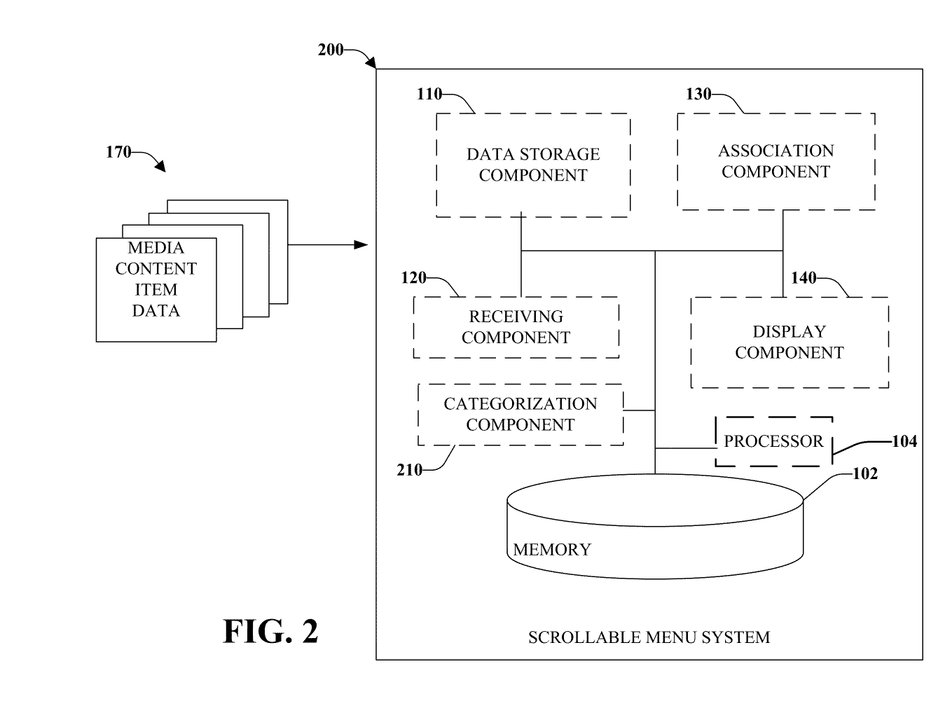

Turning now to FIG. 2, presented is another non-limiting embodiment of system 200 in accordance with the subject of the disclosure. In an aspect, categorization component 210 categorizes the scrollable set of image icons into categories of at least one of: not purchased items, purchased and ready to playback items, continue playback items, already watched play again items, or not purchased items. In an aspect, categorization component 210 is useful in organizing the scrollable set of image icons into groupings that are likely to be of interest to a user and reduce the need for independent user navigation to particular media content items 170. The categorization component 210 can base the categorization on a similarity feature, relevance, or user preference.

In an aspect, the user preference can be related to historical data corresponding to a user's online conduct, behavior, and activities. As such, categorization component 210 can categorize the scrollable set of images into groupings of not purchased items, purchased and ready to playback items, continue playback items, already watched play again items, or not purchased items. These groupings refer to a user's activity or non-activity related to a set of image icons associated with respective media content item 170. In an aspect, ready to playback items indicate the ability of a user to preview a segment or the entirety of a media content item 170 thereby enabling the user to make a more informed choice prior to purchase or download of the respective item. Additionally, in an aspect, a category of continue playback items allows a user to consume a media content item 170 from the data point the user previously discontinued consuming the media content item 170.

The category of already watched play again items refers to media content items 170 previously viewed in its entirety, whereby the user can consume the content again. In an aspect, categorization component 210 can categorize a set of images associated with media content items 170 into the not purchased item category whereby a user may have previously browsed, clicked on, searched, or scrolled over a respective item but not purchased the item. This category can inform a user of media content items 170 considered for consumption previously but not purchased or make a user aware of an item the user did not know existed but of possibly interest for consumption. The categorization component 210 can categorize the scrollable set of image icons to reflect media content items 170 from a variety of categories. Thus the categorization component 210 can create categories from other categories of sets of image icons. For instance, a category could comprise videos from the same soap opera series, however, the set of images can be comprised of an image of an episode not purchased, an image of an episode previously purchased and ready to playback, an image of an episode previously viewed not to completion and available for continue playback, an episode already watched and available for play again, or an episode not purchased. In an instance, all such episodes can be from the same series or from similar series.

Additionally, categorization component 210 can categorize a set of image icons associated with media content items 170 into categories not-related to the substance of the media content items 170 but instead related to the characteristics of the video, audio or image technology itself. Thus categorization component 210 can categorize a set of image icons based on any of the format of content, type of content interface preferred, display resolution, video quality, audio quality, bit rate, number of frames per second, aspect ratio, scaling formats, audio output options, display options, and other technical information. For instance, a category can group together a set of images related to audio data based on the ability of the file format (e.g. MIDI, WAV, MP3, AIFF, WMA, etc.) to compress sound, maintain a sound quality, ability to restrict or share the data, or the ability to embed comments in the audio file. Thus categorization component 210 can categorize a set of images generally or based on levels of categorization to allow for greater category specifications.

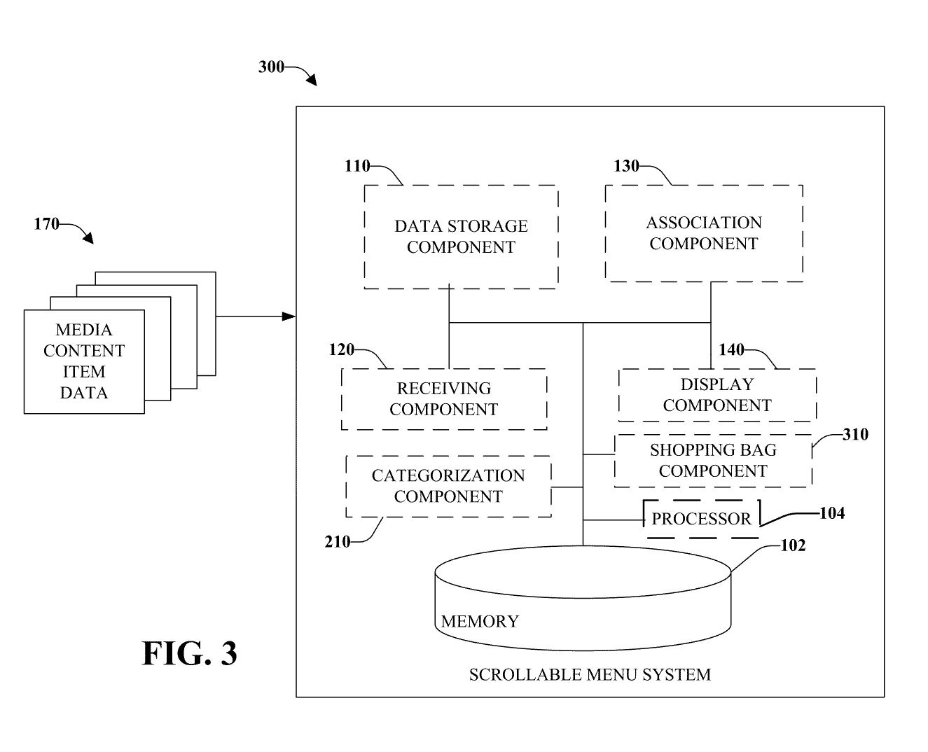

Turning now to FIG. 3, presented is another non-limiting embodiment of system 300 in accordance with the subject of the disclosure. In an aspect, shopping bag component 310 enables selection of a subset of the media content items 170 for storage in association with bag data representative of a bag, wherein the subset of the media content items 170 associated with the bag data are at least one of stored, accessed, shared, or purchased at the user device. A bag is a wish list employed with a shopping portal residing on a server computer that is accessible by a client computer. A bag is utilized in a themed social context, where shopping items to be purchased online and related information are shared among users who are associated with each other. Users may add items to their own bags, and may also recommend items to be added to their friend's bags when authorized.

For example, there may be sharing of media content items 170 and related information with users associated with friends in social networks, where groups of users allow each other to access each respective bag to add items, comments on particular items, ratings, and other information to enhance the sharing experience among users. This approach opens the social networking community up to a shopping experience that connects products (e.g. videos, songs, books) available for purchase with the community collaboration that is widely seen in social networks, where people gather online to share, comment and recommend things to each other. Retailers and shopping portal websites may also take advantage by providing their own enhancements that enable the collaboration among users. The shopping bag component 310 enables selection of a subset of the media content items 170 for storage in association with bag data representative of the bag.

For instance, a user via a user device can scroll through sets of images representative of media content items 170. After the user selects (via the device) one or more media content items 170 to view, download, purchase, or consume; the user can choose to add the media content items 170 to the users' respective bags. A user enabled to add media content items 170 to a bag is known as a member. The media data associated with the subset of media content items 170 are added to bag data wherein the subset of the media content items 170 associated with the bag data can be stored, accessed, shared, or purchased by the user device. For example, a user device can scroll through a set of image icons and select a video of interest to add to the bag. Additionally, a subset of the media content items associated with the bag data are searchable as a scrollable set of image icons for selection at the user device. Further, the subset of the media content items associated with the bag data are enabled to at least one of be purchased, have a paused playback, have a continued playback, have a forwarded playback, have a rewinded playback, have a slowdowned playback, or be refreshed, in response to input received by the user device.

In an aspect, the user device can store the video in the bag for any duration of time in order to aggregate numerous media content items 170 of interest at a centralized location. In yet another aspect, the user device can access a media content item 170 in a bag for purposes of previewing, consuming or sharing, or purchasing the media content item 170 at any time. The user can drag and drop the item with a pointing device such as a mouse in order to store, access, share, or recommend the media content items 170. In an aspect the user can share or recommend the media content items 170 with other members of an authorized social circle. Often friends, family members, celebrities and other people of interest influence the preferences and consumption habits of users, thus by enabling sharing and recommending of media content items 170 in a bag, users can efficaciously satisfy social needs and consumer needs simultaneously.

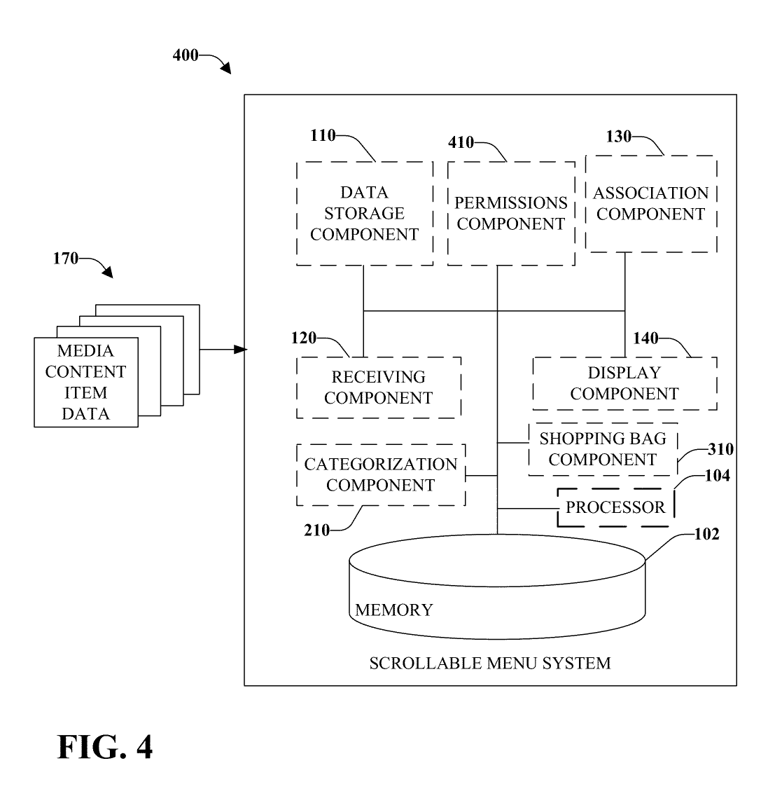

Turning now to FIG. 4, presented is another non-limiting embodiment of system 400 in accordance with the subject of the disclosure. In an aspect, permissions component 410 grants or denies a member request to access the subset of the media content items 170 associated with the bag data as a function of at least one predetermined member permission criterion. A member desiring to share media content items 170 with other members may do so by granting other members access to the bag. Each member can set permissions associated with a request to access the member's subset of media content items 170 in a bag based on predetermined member permission criterion.

The predetermined member permission criterion is a relationship between two members. Each member can specify one or more permission criterion, which qualifies members satisfying the permission criterion to access (via permissions component 410) the media content items 170, associated with the bag data. For instance, a member can specify a permission criterion of family members, whereby, members that permission component 410 qualifies as a family member are granted access to items, such as movies or audio files, in the bag of the member. Furthermore, the family member can grant the member access to the family member's bag data as well.

In an aspect, the permission criteria can be a relationship type, such as friend, classmate, colleague, or family member. In another aspect, the permission criteria can be a device user demographic, such as gender, place of living, education status, social interests, political affiliation, preferences, age, and other demographic characterizations. The permission criteria can be based on a host of different interrelationships between members so that a member can maintain privacy over media content items 170 associated with the bag data, but also share the media content items 170 with desired members. In another embodiment, device users can set permissions via permission component 410 to allow members to access some media content items 170 associated with bag data yet remain restricted from accessing other media content items 170 thus allowing for limited access to bag data. For instance, a member can permit family members under the age of 17 to access purchased movies associated with bag data that are rated PG-13, however the member can restrict the family member from viewing purchased movies associated with bag data rated R.

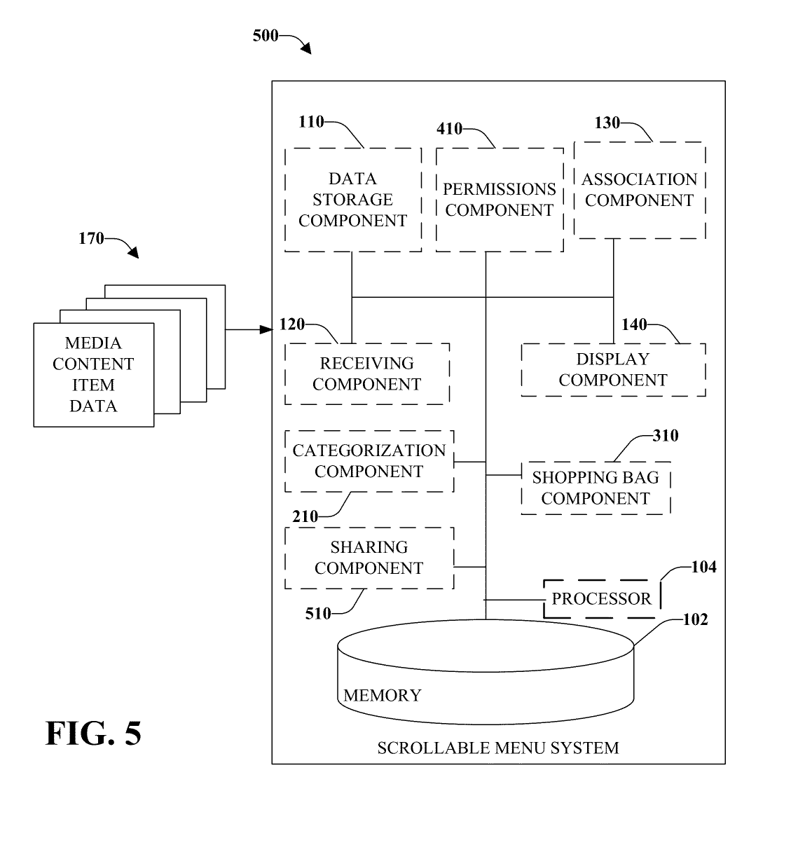

Turning now to FIG. 5, presented is another non-limiting embodiment of system 500 in accordance with the subject of the disclosure. In an aspect, sharing component 510 enables access to the subset of the media content items 170 associated with the bag data to be shared to other user devices based on an authorization of a member request to access the subset of the media content items 170 associated with the bag data. Device users often seek to share media content items 170 such as video and audio content among a group of device users. Whereas, permissions component 410 grants a member access to a subset of the media content items 170 associated with bag data, sharing component 510 enables a device user to promote and actively share the media content items 170 associated with bag data.

For instance, upon authorization of a member by permissions component 410 to access bag data of another member, the sharing component 510 enables an a member to share videos, audio content, images, digital books, purchasable items, with the authorized member. A user device may suggest or recommend media content items 170 associated with the bag data with another member. For example, a member who shares via a user device a mutual interest in a football team can share a rare documentary of the football team with another football enthusiast. Furthermore, a member who shares a hobby, interest in a subject matter, profession, or other mutual association with another member can share common items of interest with those members in order to enhance the member experience.

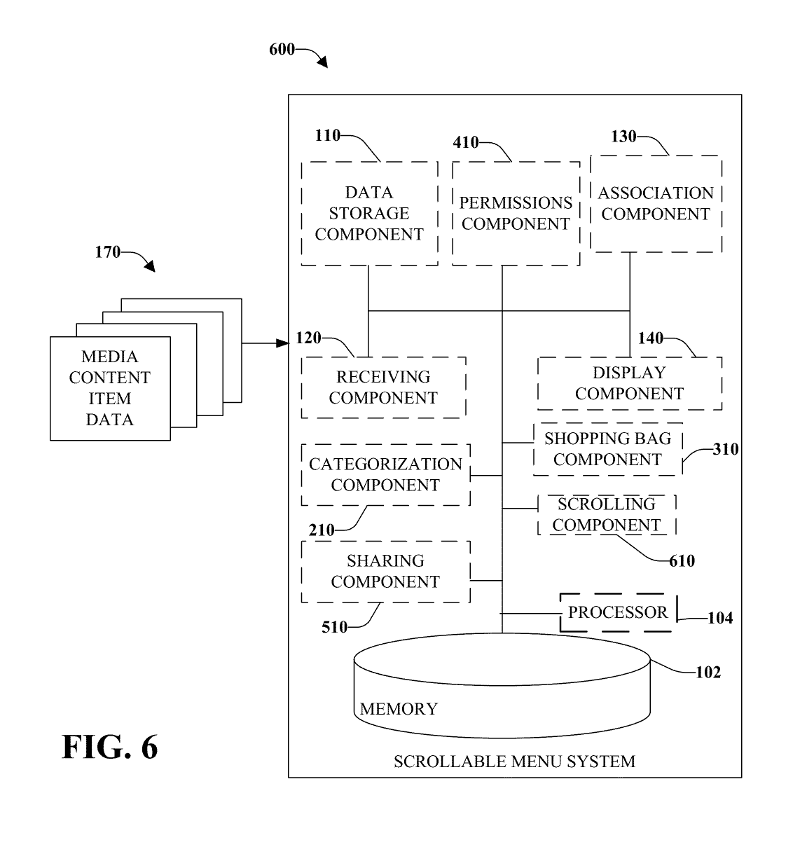

Turning now to FIG. 6, scrolling component 610 enables a scrolling through the set of image icons in at least one of a vertical direction, a horizontal direction, or a diagonal direction by the user device. In an aspect, device users can search for media content items 170 by scrolling through a set of images at a user device. Scrolling through image icons benefits a device user in that the user can capture more information in a single observation. For instance, scrolling through text requires more eye movement from a device user in order to read the content, whereas a picture or image allows for a user to observe and understand the content item without the effort of reading words. Furthermore, the image icon can be interactive, allowing the device user to directly consume the content upon clicking the image icon saving the device user the hassle of waiting for the content to appear in a new window, new tab, or new site.

In an aspect, scrolling component 610 enables the device user to scroll through the set of image icons in a variety of directions such as a vertical direction, horizontal direction or diagonal direction. In an aspect, scrolling component 610 enables vertical scrolling through a set of image icons whereby a device can move images from north to south or south to north on a scroll menu. In another aspect, scrolling component 610 enables horizontal scrolling through a set of image icons whereby a device can move images from west to east or east to west on a scroll menu. In yet another aspect, scrolling component 610 enables diagonal scrolling through a set of image icons whereby a device can move images from north-west to south-east; south-east to north-west; north-east to south-west; or south-west to north-east on a scroll menu.

The scrolling component 610 can enable diagonal scrolling of the set of images at various diagonal angles. Furthermore, scrolling component 610 can adjust the size and shape of each image item and configure the color settings at the user device. Accordingly, scrolling component 610 can configure the scrolling to be compatible with mobile devices such as a mobile device in order to accommodate screen size limitations of the mobile device and limitations in scrolling techniques, such as diagonal scrolling which may be difficult for a device user to operate on a smaller screen. In an aspect, scrolling component 610 can configure the scrolling to operate on a touch screen whereby a device user can easily flip through images merely by moving fingers across the image to slide to the previous or following image.

In another aspect, scrolling component 610 can create a 3-Dimensional illusion for the set of images moving within a scroll menu by using layers. For instance, the image icon can appear to project outward from the screen and the previous or following image can appear to be a farther distance from the device user. Also, in an aspect, scrolling component 610 can implement a scrolling technique whereby the device user can apply a flicking gesture to the set of image icons thereby applying momentum to the set of images to present faster scrolling. For instance, a user can flick a reel of images and the images can continuously move through the set of images at a fast speed and slowly reduce the speed until the scrolling stops on an image icon far along the list of images immediately following the original image flicked.

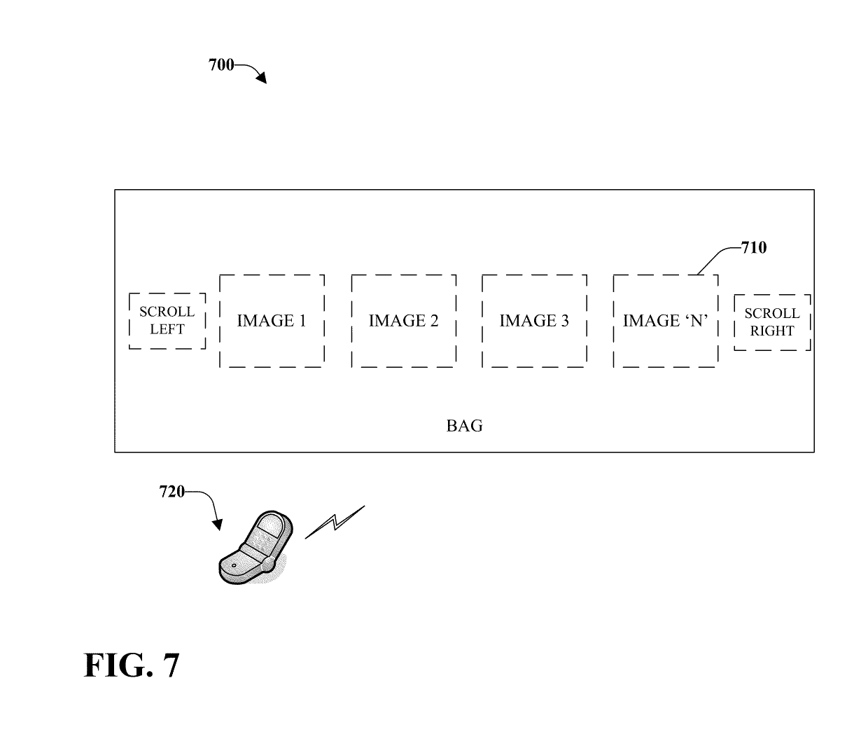

Turning now to FIG. 7, illustrated is an example non-limiting example of a system 700 for selecting and scrolling media content 170 associated with media content items in a bag. Shown are N image icons 710 in a horizontal display, wherein N is an integer. For instance, if the bag contains bag date associated with 150 media content items 170, then N=150, whereby a set of 150 image icons associated with 150 media content items are presented to a device user in a scrollable manner. Furthermore, clickable scroll options 730 allow for scrolling horizontally through the set of image icons.

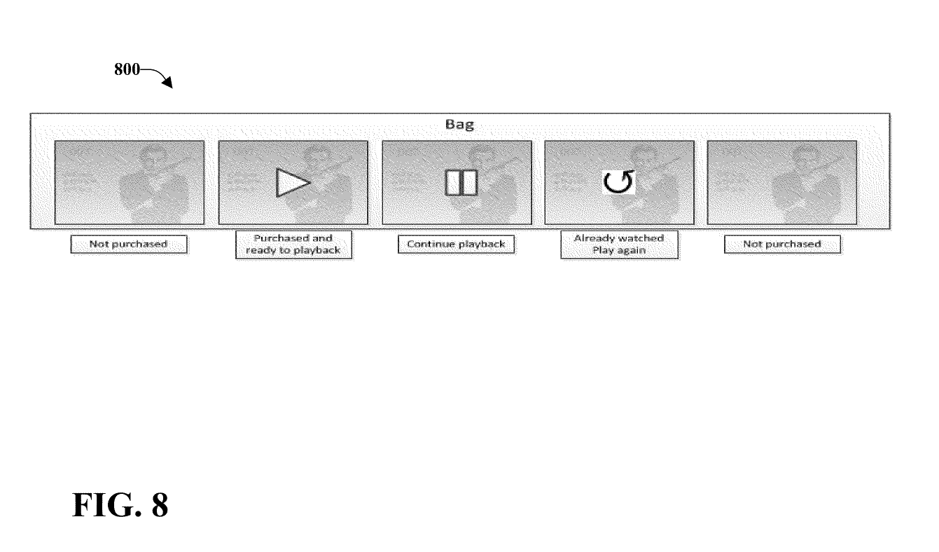

Turning now to FIG. 8, illustrated is an example non-limiting example of a system 800 for selecting and scrolling media content 170 associated with media content items in a bag. A set of image icons associated with media content items 170 are present in the bag in association with bag data. Each image icon can be stored, accessed, purchased, or played from within the bag. Furthermore, each image icon can represent a media content item 170 from a group of image icons such as not purchased media content items 170, purchased and ready to playback media content items 170, continue playback items, already watched play again media content items 170, or not purchased media content items 170. Furthermore, each image icon allows for a device to purchase a not purchased media content item 170, purchase and playback a media content item 170, continue playback a media content item 170, or play again an already watched media content item 170 from within the bag.

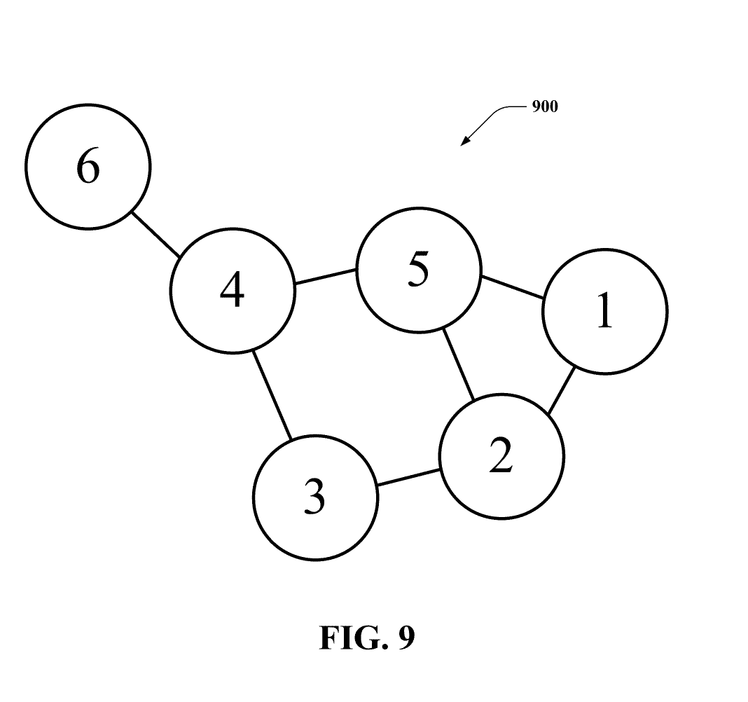

Turning now to FIG. 9, illustrated is an example non-limiting example of a social graph. In various embodiments described herein, reference is made with respect to a user's “social presence” or to a user's “friends” of a “social network.” It is to be noted that such terms are used in an online context to generally to refer to an underlying social graph. A social graph is a term coined by those working in the social areas of graph theory. It has been described as data structure(s) representing “the global mapping of everybody and how they're related”. Online social networks take advantage of social graphs by examining the relationships between individuals to offer a richer online experience. The term can be used to refer to an individual's social graph, e.g., the connections and relationships pertinent to that individual, or the term can also refer to all Internet users and their complex relationships.

In this regard, while a graph is an abstract concept used in discrete mathematics, a social graph describes the relationships between individuals online, e.g., a representation or description of relationships in the real world. A social graph is a sociogram that represents personal relations. In this regard, a social graph is a data representation, and can be defined explicitly by its associated connections, and stored in or across computer memory(ies). Social graph information can be exposed to websites, applications and services in order to take advantage of the rich information, e.g., demographic information, embodied by the graph information and associated data and metadata about the individuals comprising the graph. Example members 1, 2, 3, 4, 5 and 6 of an exemplary non-limiting social graph of interconnected members 900 is depicted in FIG. 9.

The concept of a social graph is not limited to just interconnections of people, but rather websites, applications and services can draw information about various objects and information, e.g., photos, audio, events, web pages, etc. and their relationships. This expands the social graph concept to more than just relationships between individuals and instead applies it to virtual non-human objects between individuals, as well.

Thus in various embodiments described herein, each service member can be allocated a personal social space associated with one or more bags. The personal social space can include list of user virtual friends, which allows users to view the content of their friends' bags, to view the list of items recommended by the user friends, to search for new items of interest based on friends' comments and dislikes per personal user context, view the list of friends' social activities, and so on. For instance, the following activity types are considered as social: an item is purchased by a service member's friend, an item is rated by a service member's friend, an item is favored by a service member's friend, etc., though by no means is the foregoing list inclusive or exhaustive as many other activities are considered social. Further, the user may select items of interest to preview, to add to own bag or to purchase items, and so on.

Additionally, recommendations can be made based on a member's social graph and may be provided by directly recommending an item with an optional private message to one or more user friends, by rating an item, by writing a review, by commenting to a rating or review submitted by others, etc. Social data can be homegrown or sourced from third parties, or a combination. For instance, any third party social networks and other online spaces where user interactions is permitted can be leveraged for social mapping information related to a given social graph, such as product discussion forums, fan sites, product news sites, online product databases, online recommendation and references sites, dictionaries, wikis, user blogs′, search engines, decision guides, search engines, social network services, etc. Information exchange with social networks can be implemented through open authorization protocol, and depending on the social network related functionality, to allow standard and secure application programming interface (API) multi-domain authentication and authorization without exposing the user's credentials.

Thus, optionally, visitors/users may login into the system using their social network accounts or other sources of social data. Additionally, the various embodiments for the above-described bag services may import from personal user context data, user friends list and aggregated user context data from third party social networks. Furthermore, notifications of user social activities can be posted at the user's social network personal space, and thus the communication with such third-party social network services can be bi-directional, benefitting both systems with additional input. Such interaction provides an opportunity of expanding target audiences beyond a given set of members and allows an opportunity to send communications to third party social network friends, e.g., invitations to third party social network friends (personal or common) to join the service.

Also, the bag need not be considered a flat structure. The bag may include multiple levels, e.g., hierarchical levels, some of which may be categorized by the user-owner of the bag, who has ultimate authority of its control and maintenance. A user may categorize different portions of the bag into areas for maintenance and/or display for different individuals, groups or subgroups. For example, in a social networking environment, a person may want to segregate different areas from various users, such as a parent wanting to show or otherwise share content or information to adult friends separately from children and young adults. A user may further want to separate items that the user chooses or submits into the user's bag from items other users submit to the user's Bag. The user may also restrict or otherwise control submissions by certain or possibly all users into the user's Bag, and may even prohibit any submissions altogether.

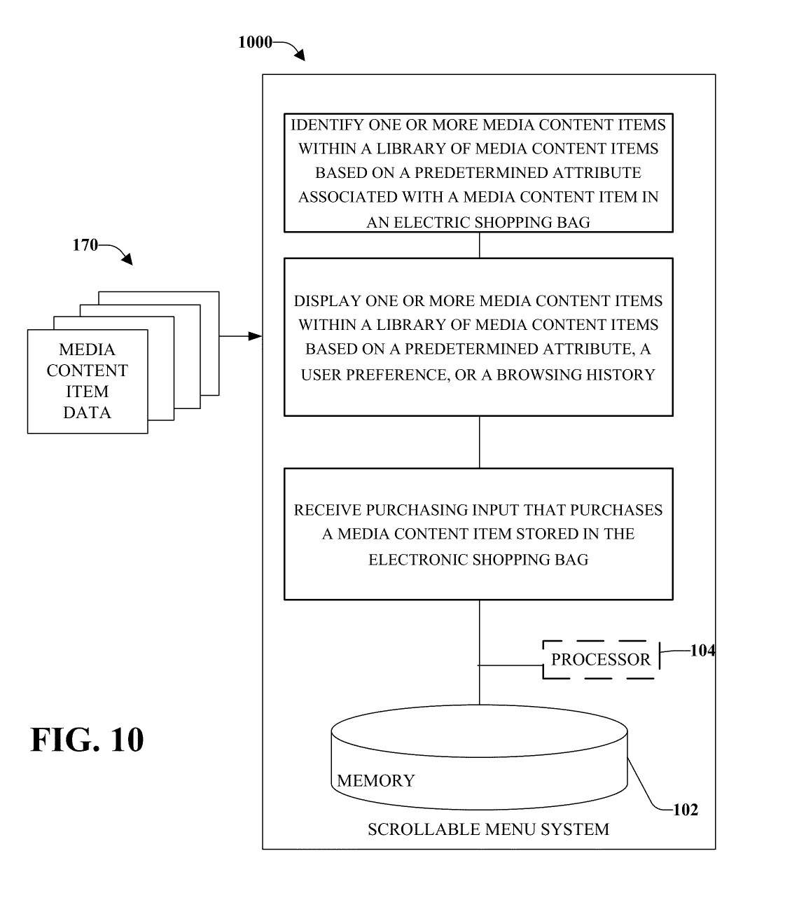

Referring now to FIG. 10 presented is a flow diagram of an example application of systems disclosed in this description in accordance with an embodiment. In an aspect, exemplary system 1000, comprises a memory 102 to store computer-executable instructions; a processor 104 communicatively coupled to the memory 102, that executes or facilitates execution of the computer-executable instructions to at least: identify one or more media content items 170 within a library of media content items 170 based on a predetermined attribute associated with a media content item 170 in an electronic shopping bag; display recommended media content items based on any one of: the predetermined attribute, a user preference, or a browsing history; and receive purchasing input that purchases a media content item stored in the electronic shopping bag.

Furthermore, in an aspect, the processor can further execute or facilitate execution of the computer-executable instructions to share media content items within the electronic shopping bag to one or more other devices associated with selected user identities. In another aspect, the processor can further execute or facilitate execution of the computer-executable instructions to receive functional input corresponding to performance of functions of media content items in the electronic shopping bag, wherein the functions include at least one of a purchase of an item, a viewing of an item, a search of an item, a recommendation of an item, an addition of an item to a set of user designated favorites, a deletion of an item from the set of user designated favorites, a rating of an item, or a sharing of an item to a network device of a social media network service.

Furthermore, in an aspect the processor can further execute or facilitate execution of the computer-executable instructions to receive an image from a video or image data store and present the image in a scrollable set of image icons for user browsing or selection. In yet another aspect, the processor can further execute or facilitate execution of the computer-executable instructions to capture a different image or a same image for each scrollable image icon corresponding to an inferred user preference. Also, in an aspect, the image can be at least one of: a drawn digital image, a digital image captured from a video, or a digital image captured by an image capturing device. For instance, the device user can use a picture from a personal video or digital camera to as the scrollable image associated with a media content item 170.

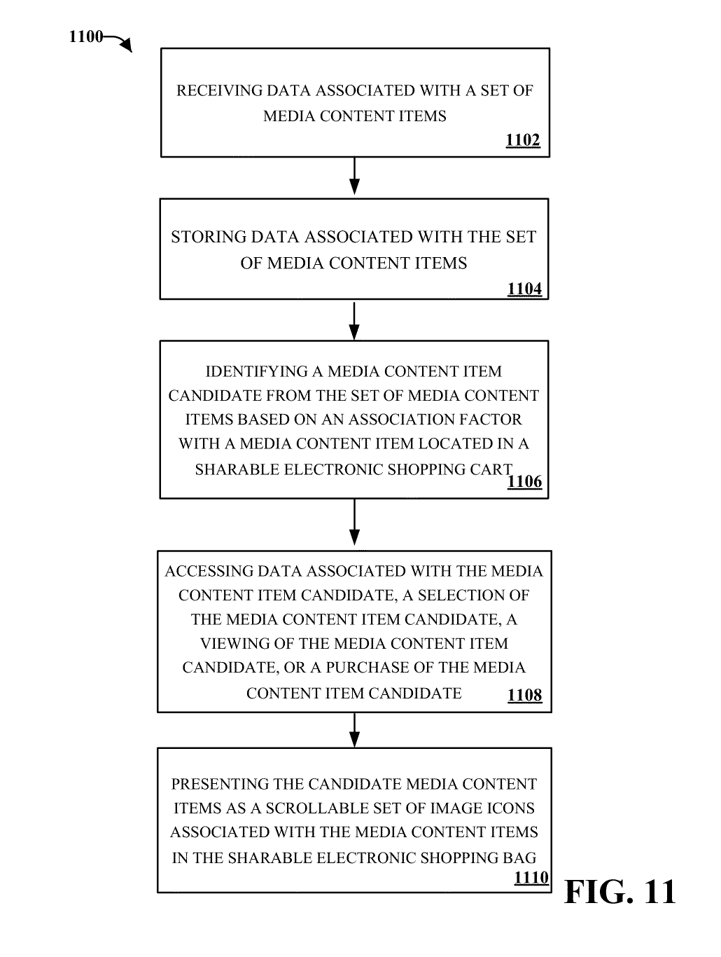

FIGS. 11-16 illustrate various methodologies in accordance with the disclosed subject matter. While, for purposes of simplicity of explanation, the methodologies are shown and described as a series of acts, it is to be understood and appreciated that the disclosed subject matter is not limited by the order of acts, as some acts may occur in different orders and/or concurrently with other acts from that shown and described herein. For example, those skilled in the art will understand and appreciate that a method can alternatively be represented as a series of interrelated states or events, such as in a state diagram. Moreover, not all illustrated acts may be required to implement a method in accordance with the disclosed subject matter. Additionally, it is to be further appreciated that the methodologies disclosed hereinafter and throughout this disclosure are capable of being stored on an article of manufacture to facilitate transporting and transferring such methodologies to computers.

Referring now to FIG. 11, presented is a flow diagram of an example application of systems disclosed in this description accordance with an embodiment. In an aspect, exemplary method 1100 of a scrollable menu system is disclosed. At 1102, data associated with a set of media content items 170 is received. At 1104, the data associated with the set of media content items 170 is stored. At 1106, a media content item candidate from the set of media content items 170 based on an association factor with a media content item 170 located in a sharable electronic shopping bag is identified. At 1108, data associated with the media content item candidate for at least one of facilitating: a browsing of the media content item candidate, a selection of the media content item candidate, a viewing of the media content item candidate, or a purchase of the media content item candidate, are accessed. At 1110, the candidate media content items as a scrollable set of image icons associated with the media content items in the sharable electronic shopping bag are presented.

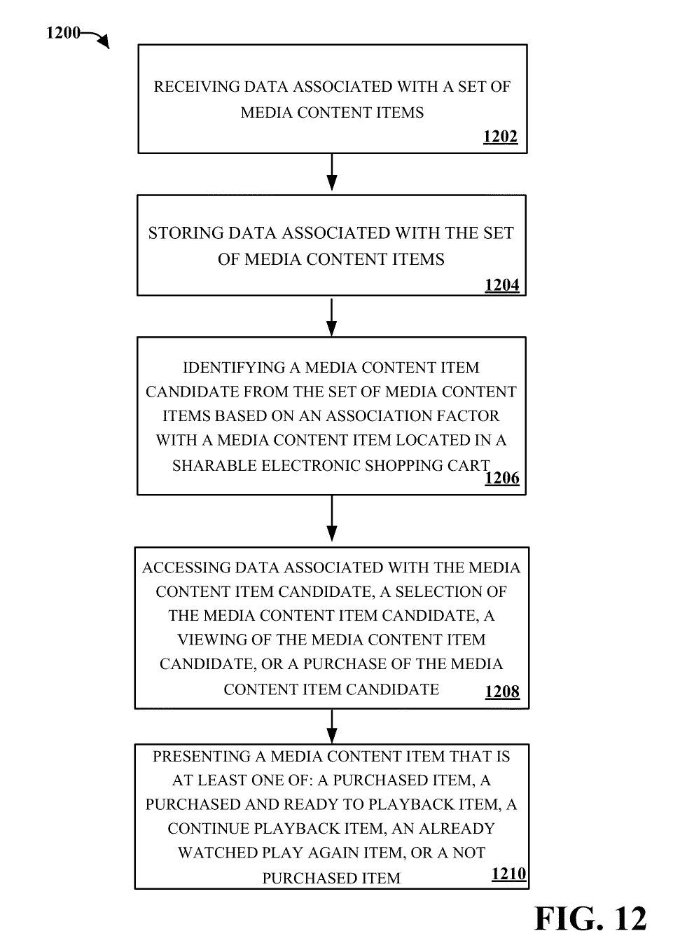

Referring now to FIG. 12, presented is a flow diagram of an example application of systems disclosed in this description accordance with an embodiment. In an aspect, exemplary method 1200 of a scrollable menu system is disclosed. At 1202, a data associated with a set of media content items 170 is received. At 1204, the data associated with the set of media content items 170 is stored. At 1206, a media content item candidate from the set of media content items 170 based on an association factor with a media content item 170 located in a sharable electronic shopping bag is identified. At 1208, data associated with the media content item candidate for at least one of facilitating: a browsing of the media content item candidate, a selection of the media content item candidate, a viewing of the media content item candidate, or a purchase of the media content item candidate, are accessed. At 1210, a media content item of the media content items that is at least one of: a purchased item, a purchased and ready to playback item, a continue playback item, an already watched play again item, or a not purchased item, are presented.

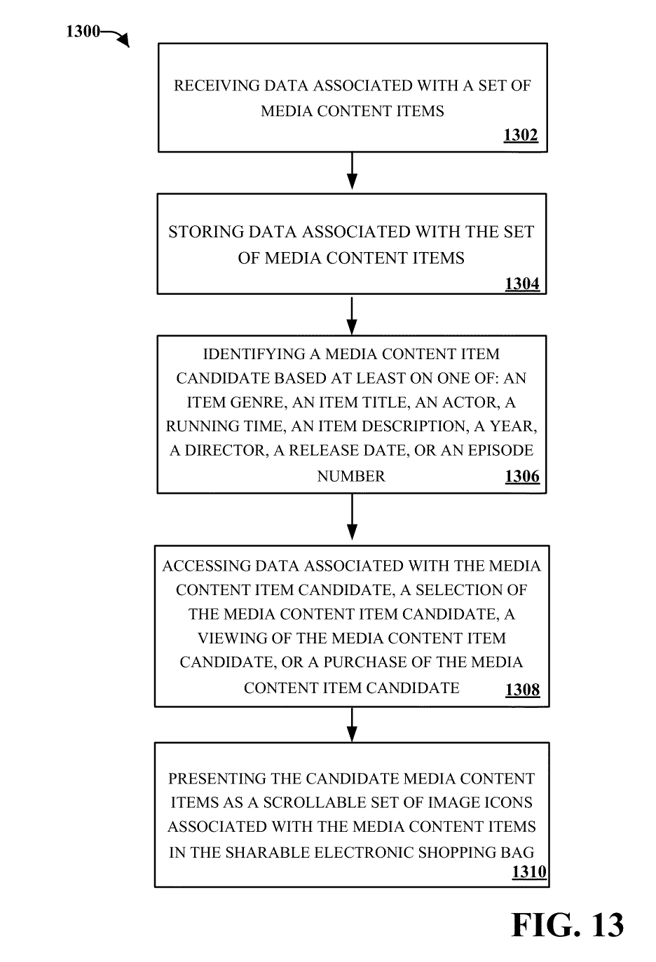

Referring now to FIG. 13, presented is a flow diagram of an example application of systems disclosed in this description accordance with an embodiment. In an aspect, exemplary method 1300 of a scrollable menu system is disclosed. At 1302, data associated with a set of media content items 170 is received. At 1304, the data associated with the set of media content items 170 is stored. At 1306, a media content item candidate of the candidate media content items based at least on one of: an item genre, an item title, an actor, a running time, an item description, a year, a director, a release date, or an episode number are identified. At 1308, data associated with the media content item candidate for at least one of facilitating: a browsing of the media content item candidate, a selection of the media content item candidate, a viewing of the media content item candidate, or a purchase of the media content item candidate, are accessed. At 1310, the candidate media content items as a scrollable set of image icons associated with the media content items in the sharable electronic shopping bag are presented.

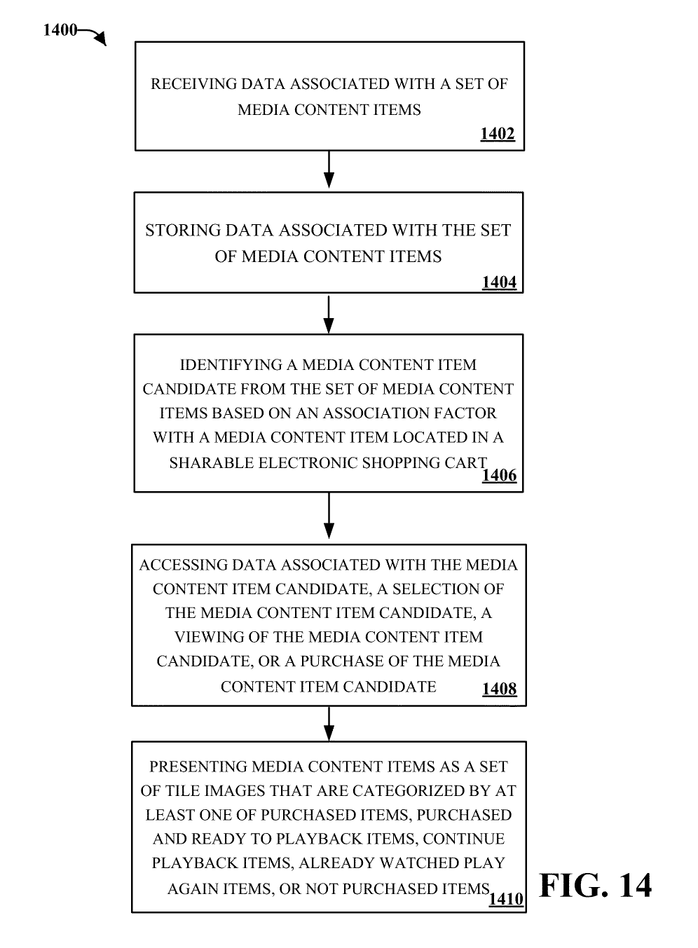

Referring now to FIG. 14, presented is a flow diagram of an example application of systems disclosed in this description accordance with an embodiment. In an aspect, exemplary method 1400 of a scrollable menu system is disclosed. At 1402, data associated with a set of media content items 170 is received. At 1404, the data associated with the set of media content items 170 is stored. At 1406, a media content item candidate from the set of media content items 170 based on an association factor with a media content item 170 located in a sharable electronic shopping bag is identified. At 1408, data associated with the media content item candidate for at least one of facilitating: a browsing of the media content item candidate, a selection of the media content item candidate, a viewing of the media content item candidate, or a purchase of the media content item candidate, are accessed. At 1410, candidate media content items 170 as a set of tile images that are categorized by at least one of purchased items, purchased and ready to playback items, continue playback items, already watched play again items, or not purchased items are presented.

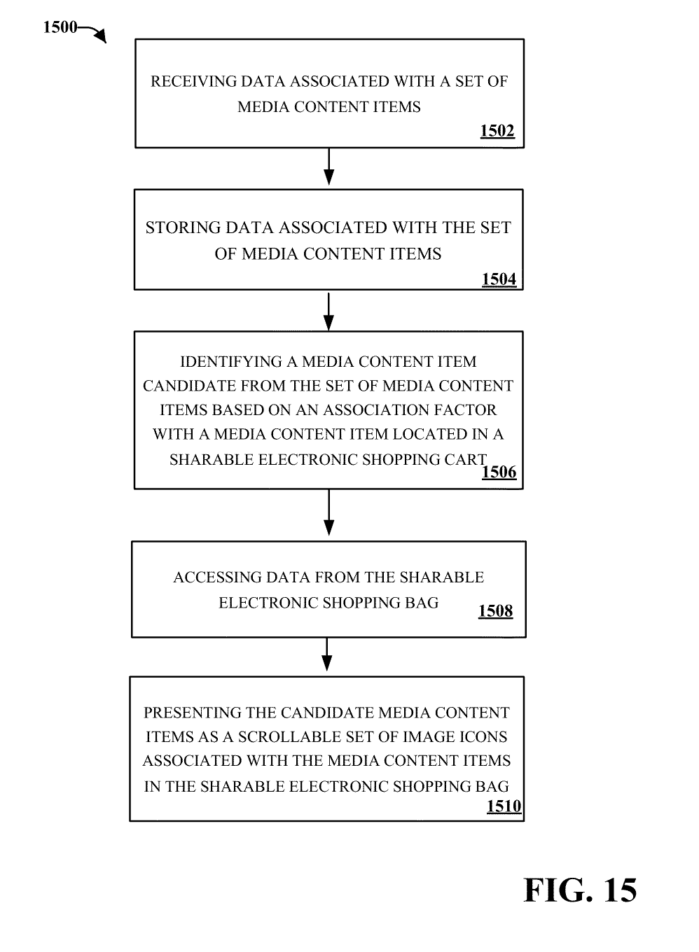

Referring now to FIG. 15, presented is a flow diagram of an example application of systems disclosed in this description accordance with an embodiment. In an aspect, exemplary method 1500 of a scrollable menu system is disclosed. At 1502, data associated with a set of media content items 170 is received. At 1504, the data associated with the set of media content items 170 is stored. At 1506, a media content item candidate from the set of media content items 170 based on an association factor with a media content item 170 located in a sharable electronic shopping bag is identified. At 1508, data from the sharable electronic shopping bag are accessed. At 1510, the candidate media content items as a scrollable set of image icons associated with the media content items in the sharable electronic shopping bag are presented.

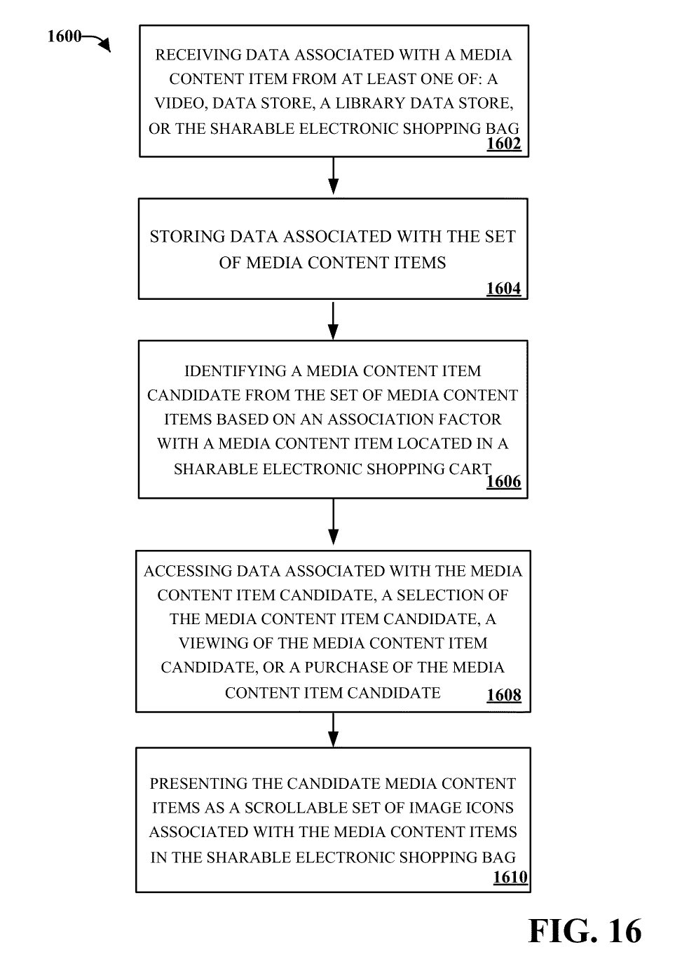

Referring now to FIG. 16, presented is a flow diagram of an example application of systems disclosed in this description accordance with an embodiment. In an aspect, exemplary method 1600 of a scrollable menu system is disclosed. At 1602, data associated with a media content item from at least one of: a video data store, a library data store, or the sharable electronic shopping bag are received. At 1604, the data associated with the set of media content items 170 is stored. At 1606, a media content item candidate from the set of media content items 170 based on an association factor with a media content item 170 located in a sharable electronic shopping bag is identified. At 1608, data associated with the media content item candidate for at least one of facilitating: a browsing of the media content item candidate, a selection of the media content item candidate, a viewing of the media content item candidate, or a purchase of the media content item candidate, are accessed. At 1610, the candidate media content items as a scrollable set of image icons associated with the media content items in the sharable electronic shopping bag are presented.

### Example Operating Environments

The systems and processes described below can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders, not all of which may be explicitly illustrated in this disclosure.

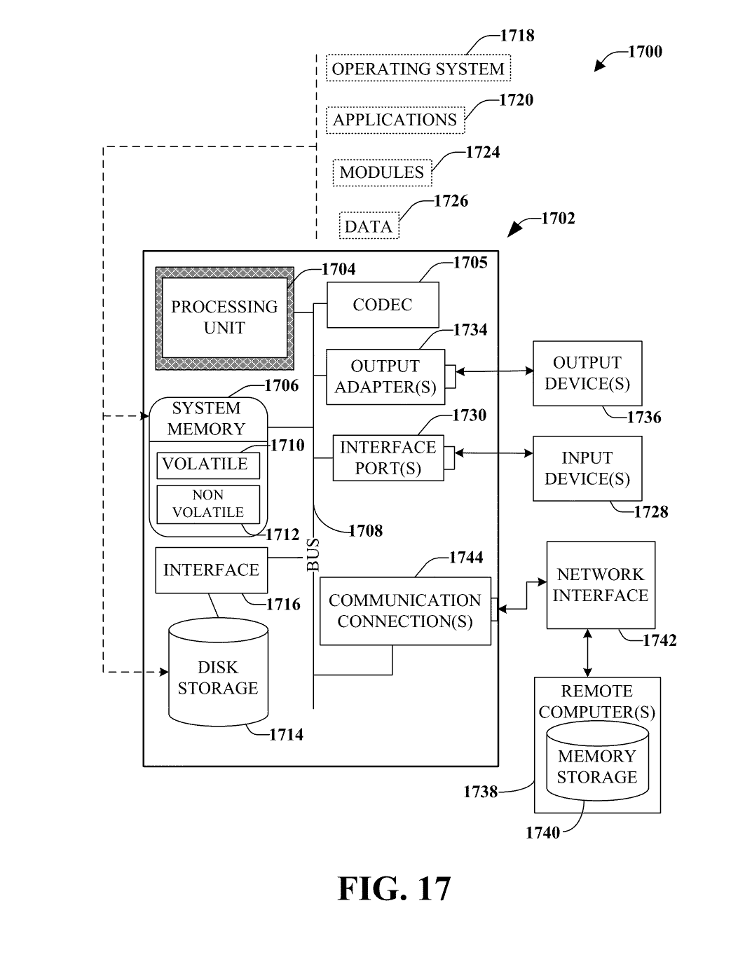

With reference to FIG. 17, a suitable environment 1700 for implementing various aspects of the claimed subject matter includes a computer 1702. The computer 1702 includes a processing unit 1704, a system memory 1706, a codec 1705, and a system bus 1708. The system bus 1708 couples system components including, but not limited to, the system memory 1706 to the processing unit 1704. The processing unit 1704 can be any of various available processors. Dual microprocessors and other multiprocessor architectures also can be employed as the processing unit 1704.

The system bus 1708 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1706 includes volatile memory 1710 and non-volatile memory 1712. The basic input/output system (BIOS), containing the basic routines to transfer information between elements within the computer 1702, such as during start-up, is stored in non-volatile memory 1712. In addition, according to present innovations, codec 1705 may include at least one of an encoder or decoder, wherein the at least one of an encoder or decoder may consist of hardware, a combination of hardware and software, or software. Although, codec 1705 is depicted as a separate component, codec 1705 may be contained within non-volatile memory 1712. By way of illustration, and not limitation, non-volatile memory 1712 can include read only memory (ROM), programmable ROM (PROM), electrically programmable ROM (EPROM), electrically erasable programmable ROM (EEPROM), or flash memory. Volatile memory 1710 includes random access memory (RAM), which acts as external cache memory. According to present aspects, the volatile memory may store the write operation retry logic (not shown in FIG. 17) and the like. By way of illustration and not limitation, RAM is available in many forms such as static RAM (SRAM), dynamic RAM (DRAM), synchronous DRAM (SDRAM), double data rate SDRAM (DDR SDRAM), and enhanced SDRAM (ESDRAM.

Computer 1702 may also include removable/non-removable, volatile/non-volatile computer storage medium. FIG. 17 illustrates, for example, disk storage 1714. Disk storage 1714 includes, but is not limited to, devices like a magnetic disk drive, solid state disk (SSD) floppy disk drive, tape drive, external drive, flash memory card, or memory stick. In addition, disk storage 1714 can include storage medium separately or in combination with other storage medium including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1714 to the system bus 1708, a removable or non-removable interface is typically used, such as interface 1716.

It is to be appreciated that FIG. 17 describes software that acts as an intermediary between users and the basic computer resources described in the suitable operating environment 1700. Such software includes an operating system 1718. Operating system 1718, which can be stored on disk storage 1714, acts to control and allocate resources of the computer system 1702. Applications 1720 take advantage of the management of resources by the operating system through program modules 1724, and program data 1726, such as the boot/shutdown transaction table and the like, stored either in system memory 1706 or on disk storage 1714. It is to be appreciated that the claimed subject matter can be implemented with various operating systems or combinations of operating systems.

A user enters commands or information into the computer 1702 through input device(s) 1728. Input devices 1728 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1704 through the system bus 1708 via interface port(s) 1730. Interface port(s) 1730 include, for example, a serial port, a parallel port, a game port, and a universal serial bus (USB). Output device(s) 1736 use some of the same type of ports as input device(s) 1728. Thus, for example, a USB port may be used to provide input to computer 1702, and to output information from computer 1702 to an output device 1736. Output adapter 1734 is provided to illustrate that there are some output devices 1736 like monitors, speakers, and printers, among other output devices 1736, which require special adapters. The output adapters 1734 include, by way of illustration and not limitation, video and sound cards that provide a means of connection between the output device 1736 and the system bus 1708. It should be noted that other devices and/or systems of devices provide both input and output capabilities such as remote computer(s) 1738.

Computer 1702 can operate in a networked environment using logical connections to one or more remote computers, such as remote computer(s) 1738. The remote computer(s) 1738 can be a personal computer, a server, a router, a network PC, a workstation, a microprocessor based appliance, a peer device, a smart phone, a tablet, or other network node, and typically includes many of the elements described relative to computer 1702. For purposes of brevity, only a memory storage device 1740 is illustrated with remote computer(s) 1738. Remote computer(s) 1738 is logically connected to computer 1702 through a network interface 1742 and then connected via communication connection(s) 1744. Network interface 1742 encompasses wire and/or wireless communication networks such as local-area networks (LAN) and wide-area networks (WAN) and cellular networks. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1744 refers to the hardware/software employed to connect the network interface 1742 to the bus 1708. While communication connection 1744 is shown for illustrative clarity inside computer 1702, it can also be external to computer 1702. The hardware/software necessary for connection to the network interface 1742 includes, for exemplary purposes only, internal and external technologies such as, modems including regular telephone grade modems, cable modems and DSL modems, ISDN adapters, and wired and wireless Ethernet cards, hubs, and routers.

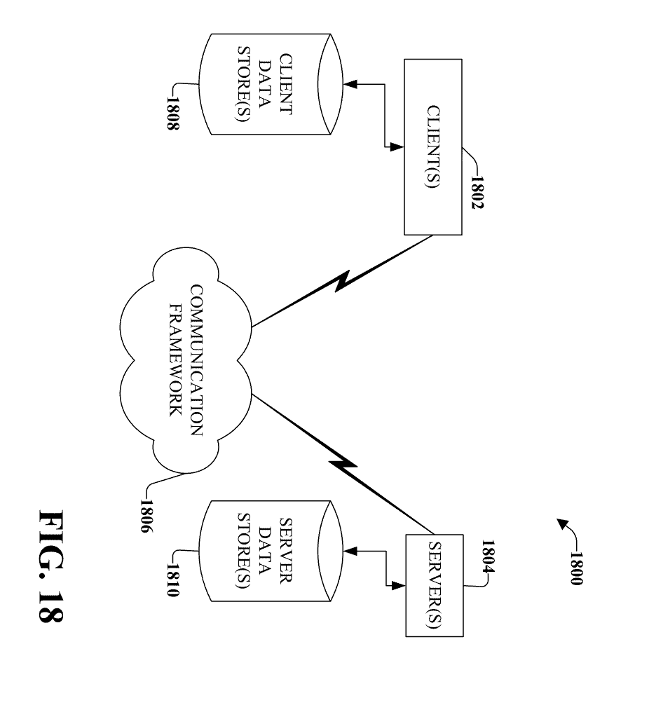

Referring now to FIG. 18, there is illustrated a schematic block diagram of a computing environment 1800 in accordance with this disclosure. The system 1800 includes one or more client(s) 1802 (e.g., laptops, smart phones, PDAs, media players, computers, portable electronic devices, tablets, and the like). The client(s) 1802 can be hardware and/or software (e.g., threads, processes, computing devices). The system 1800 also includes one or more server(s) 1804. The server(s) 1804 can also be hardware or hardware in combination with software (e.g., threads, processes, computing devices). The servers 1804 can house threads to perform transformations by employing aspects of this disclosure, for example. One possible communication between a client 1802 and a server 1804 can be in the form of a data packet transmitted between two or more computer processes wherein the data packet may include video data. The data packet can include a metadata, such as associated contextual information for example. The system 1800 includes a communication framework 1806 (e.g., a global communication network such as the Internet, or mobile network(s)) that can be employed to facilitate communications between the client(s) 1802 and the server(s) 1804.

Communications can be facilitated via a wired (including optical fiber) and/or wireless technology. The client(s) 1802 include or are operatively connected to one or more client data store(s) 1808 that can be employed to store information local to the client(s) 1802 (e.g., associated contextual information). Similarly, the server(s) 1804 are operatively include or are operatively connected to one or more server data store(s) 1810 that can be employed to store information local to the servers 1804.

In one embodiment, a client 1802 can transfer an encoded file, in accordance with the disclosed subject matter, to server 1804. Server 1804 can store the file, decode the file, or transmit the file to another client 1802. It is to be appreciated, that a client 1802 can also transfer uncompressed file to a server 1804 and server 1804 can compress the file in accordance with the disclosed subject matter. Likewise, server 1804 can encode video information and transmit the information via communication framework 1806 to one or more clients 1802.

The illustrated aspects of the disclosure may also be practiced in distributed computing environments where certain tasks are performed by remote processing devices that are linked through a communications network. In a distributed computing environment, program modules can be located in both local and remote memory storage devices.

Moreover, it is to be appreciated that various components described in this description can include electrical circuit(s) that can include components and circuitry elements of suitable value in order to implement the embodiments of the subject innovation(s). Furthermore, it can be appreciated that many of the various components can be implemented on one or more integrated circuit (IC) chips. For example, in one embodiment, a set of components can be implemented in a single IC chip. In other embodiments, one or more of respective components are fabricated or implemented on separate IC chips.

What has been described above includes examples of the embodiments of the present invention. It is, of course, not possible to describe every conceivable combination of components or methodologies for purposes of describing the claimed subject matter, but it is to be appreciated that many further combinations and permutations of the subject innovation are possible. Accordingly, the claimed subject matter is intended to embrace all such alterations, modifications, and variations that fall within the spirit and scope of the appended claims. Moreover, the above description of illustrated embodiments of the subject disclosure, including what is described in the Abstract, is not intended to be exhaustive or to limit the disclosed embodiments to the precise forms disclosed. While specific embodiments and examples are described in this disclosure for illustrative purposes, various modifications are possible that are considered within the scope of such embodiments and examples, as those skilled in the relevant art can recognize.

In particular and in regard to the various functions performed by the above described components, devices, circuits, systems and the like, the terms used to describe such components are intended to correspond, unless otherwise indicated, to any component which performs the specified function of the described component (e.g., a functional equivalent), even though not structurally equivalent to the disclosed structure, which performs the function in the disclosure illustrated exemplary aspects of the claimed subject matter. In this regard, it will also be recognized that the innovation includes a system as well as a computer-readable storage medium having computer-executable instructions for performing the acts and/or events of the various methods of the claimed subject matter.

The aforementioned systems/circuits/modules have been described with respect to interaction between several components/blocks. It can be appreciated that such systems/circuits and components/blocks can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described in this disclosure may also interact with one or more other components not specifically described in this disclosure but known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), a combination of hardware and software, software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables the hardware to perform specific function; software stored on a computer readable storage medium; software transmitted on a computer readable transmission medium; or a combination thereof.

Moreover, the words “example” or “exemplary” are used in this disclosure to mean serving as an example, instance, or illustration. Any aspect or design described in this disclosure as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Computing devices typically include a variety of media, which can include computer-readable storage media and/or communications media, in which these two terms are used in this description differently from one another as follows. Computer-readable storage media can be any available storage media that can be accessed by the computer, is typically of a non-transitory nature, and can include both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal that can be transitory such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

In view of the exemplary systems described above, methodologies that may be implemented in accordance with the described subject matter will be better appreciated with reference to the flowcharts of the various figures. For simplicity of explanation, the methodologies are depicted and described as a series of acts. However, acts in accordance with this disclosure can occur in various orders and/or concurrently, and with other acts not presented and described in this disclosure. Furthermore, not all illustrated acts may be required to implement the methodologies in accordance with certain aspects of this disclosure. In addition, those skilled in the art will understand and appreciate that the methodologies could alternatively be represented as a series of interrelated states via a state diagram or events. Additionally, it should be appreciated that the methodologies disclosed in this disclosure are capable of being stored on an article of manufacture to facilitate transporting and transferring such methodologies to computing devices. The term article of manufacture, as used in this disclosure, is intended to encompass a computer program accessible from any computer-readable device or storage media.

What is claimed is:

1. A system, comprising:
a memory to store computer-executable components; and
a processor, communicatively coupled to the memory, that executes or facilitates execution of one or more of the computer-executable components, the computer-executable components, comprising:
a data storage component that stores data associated with media content items;
a receiving component that receives the data associated with the media content items for consumption on a user device based on at least one of selection data representing a selection received from the user device or a user preference inferred for a user identity associated with the user device;
an association component that associates a media content item with one or more of the media content items based on a similarity of a feature of the media content items determined with respect to one or more features of the one or more of the media content items; and
a display component that displays the one or more of the media content items as a scrollable set of image icons associated with respective media content items that respectively enable playback, rewind, forward, search, pause, or record for selection at the user device.

2. The system of claim 1, wherein the computer-executable components further comprise a categorization component that categorizes the scrollable set of image icons into categories of at least one of: not purchased items, purchased and ready to playback items, continue playback items, already watched play again items, or not purchased items.

3. The system of claim 1, wherein the computer-executable components further comprise a shopping bag component that enables selection of a subset of the media content items for storage in association with bag data representative of a bag, wherein the subset of the media content items associated with the bag data are at least one of stored, accessed, shared, or purchased by the user device.

4. The system of claim 3, wherein the subset of the media content items associated with the bag data are searchable as a scrollable set of image icons for selection at the user device.

5. The system of claim 3, wherein the subset of the media content items associated with the bag data are enabled to at least one of be purchased, have a paused playback, have a continued playback, have a forwarded playback, have a rewinded playback, have a slowdowned playback, or be refreshed, in response to input received by the user device.

6. The system of 1, wherein the computer-executable components further comprise a permissions component that grants or denies a member request to access the subset of the media content items associated with the bag data as a function of at least one predetermined member permission criterion.

7. The system of claim 1, wherein the computer-executable components further comprise a sharing component that enables access to the subset of the media content items associated with the bag data to be shared to other user devices based on an authorization of a member request to access the subset of the media content items associated with the bag data.

8. The system of claim 1, wherein the computer-executable components further comprise a scrolling component that enables a scrolling through the set of image icons in at least one of a vertical direction, a horizontal direction, or a diagonal direction by the user device.

9. The system of claim 1, wherein the similarity is a similarity of at least one of a:
set of titles, set of episodes, format, or genre corresponding to a respective media content item.

10. A system, comprising:
a memory to store computer-executable instructions; and
a processor, communicatively coupled to the memory, that executes or facilitates execution of the computer-executable instructions to at least:
identify one or more media content items within a library of media content items based on a predetermined attribute associated with a media content item in an electronic shopping bag;
display recommended media content items based on any one of: the predetermined attribute, a user preference, or a browsing history; and
receive purchasing input that purchases a media content item stored in the electronic shopping bag.

11. The system of claim 10, wherein the processor further executes or facilitates execution of the computer-executable instructions to share media content items within the electronic shopping bag to one or more other devices associated with selected user identities.

12. The system of claim 10, wherein the processor further executes or facilitates execution of the computer-executable instructions to receive functional input corresponding to performance of functions of media content items in the electronic shopping bag, wherein the functions include at least one of a purchase of an item, a viewing of an item, a search of an item, a recommendation of an item, an addition of an item to a set of user designated favorites, a deletion of an item from the set of user designated favorites, a rating of an item, or a sharing of an item to a network device of a social media network service.

13. The system of claim 10, wherein the predetermined attribute associated with a media content item is at least one of: genre, title, common actor, running time, item description, year, director, release date, or episode number.

14. The system of claim 10, wherein the processor further executes or facilitates execution of the computer-executable instructions to receive an image from a video or image data store and present the image in a scrollable set of image icons for user browsing or selection.

15. The system of claim 14, wherein the processor further executes or facilitates execution of the computer-executable instructions to capture a different image or a same image for each scrollable image icon corresponding to an inferred user preference.

16. The system of claim 14, wherein the image is at least one of: a drawn digital image, a digital image captured from a video, or a digital image captured by an image capturing device.

17. A method, comprising:
receiving, by a system including a processor, data associated with a set of media content items;
storing the data associated with the set of media content items;
identifying a media content item candidate from the set of media content items based on an association factor with a media content item located in a sharable electronic shopping bag;
accessing data associated with the media content item candidate for at least one of facilitating: a browsing of the media content item candidate, a selection of the media content item candidate, a viewing of the media content item candidate, or a purchase of the media content item candidate; and
presenting the candidate media content items as a scrollable set of image icons associated with the media content items in the sharable electronic shopping bag.

18. The method of claim 17, wherein the presenting comprises presenting a media content item of the media content items that is at least one of: a purchased item, a purchased and ready to playback item, a continue playback item, an already watched play again item, or a not purchased item.

19. The method of claim 17, wherein the identifying comprises identifying a media content item candidate of the candidate media content items based at least on one of: an item genre, an item title, an actor, a running time, an item description, a year, a director, a release date, or an episode number.

20. The method of claim 17, wherein the presenting comprises presenting the candidate media content items as a set of tile images that are categorized by at least one of purchased items, purchased and ready to playback items, continue playback items, already watched play again items, or not purchased items.

21. The method of claim 17, wherein the accessing comprises accessing the data from the sharable electronic shopping bag.

22. The method of claim 17, wherein the receiving comprises receiving the data associated with a media content item of the media content items from at least one of: a video data store, a library data store, or the sharable electronic shopping bag.
